(19) United States
(12) Patent Application Publication
(10) Pub. No.: US 2014/0135016 A1
(43) Pub. Date: May 15, 2014

(54) METHOD AND APPARATUS FOR OPTIMIZING THE FREQUENCY OF AUTONOMOUS SEARCH FUNCTIONS FOR DISCOVERING CSG CELLS

(71) Applicant: QUALCOMM INCORPORATED, San Diego, CA (US)

(72) Inventors: Aziz Gholmieh, Del Mar, CA (US); Fan Wang, Sunnyvale, CA (US); Damanjit Singh, San Diego, CA (US); An-Swol Clement Hu, Belmont, CA (US); Vikas Gulati, Hererabad (IN); Sundaresan Tambaram Kailasam, San Diego, CA (US); Uzma Khan, San Marcos, CA (US); Vitaly Drapkin, San Diego, CA (US); Thomas Klingenbrunn, San Diego, CA (US); Sathish Krishnamoorthy, Hyderabad (IN); Sumit Kumar Singh, San Diego, CA (US); Preyas Desai, San Diego, CA (US); Chetan G. Chakravarthy, San Diego, CA (US)

(73) Assignee: QUALCOMM INCORPORATED, San Diego, CA (US)

(21) Appl. No.: 13/794,358

(22) Filed: Mar. 11, 2013

Related U.S. Application Data
(60) Provisional application No. 61/724,830, filed on Nov. 9, 2012.

(51) Int. Cl. H04W 36/00

(52) U.S. Cl. CPC H04W 36/0061
USPC 455/437; 455/436

(57) ABSTRACT

Apparatus and methods of maintaining a cell database for wireless communications include discovering a second cell to which a user equipment may reselect. In an aspect, the user equipment may be currently served by a first cell and the second cell is a closed subscriber group cell. Further, aspects include querying a fingerprinting database to determine whether the second cell was previously recorded in the fingerprinting database. Upon determining that the second cell was not previously recorded, further aspects include adding the second cell to the fingerprinting database. Adding the second cell may comprise indicating an association between the first cell and the second cell in the fingerprinting database.

### CLAIM OF PRIORITY UNDER 35 U.S.C. §119

The present Application for Patent claims priority to Provisional Application No. 61/724,830 entitled “METHOD AND APPARATUS FOR OPTIMIZING THE FREQUENCY OF AUTONOMOUS SEARCH FUNCTIONS FOR DISCOVERING CSG CELLS” filed Nov. 9, 2012, and assigned to the assignee hereof and hereby expressly incorporated by reference herein.

### BACKGROUND

1. Field

Aspects of the present disclosure relate generally to wireless communication systems, and more particularly, to network selection based on user preferences.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

According to 3GPP specifications, such as, but not limited to the 3GPP TS 25.304 specification, which is incorporated herein by reference, in addition to traditional cell reselection, a user equipment (UE) should use an autonomous search function (ASF) to search for closed subscriber group (CSG) cells when at least one CSG ID with an associated public land mobile network (PLMN) identity is included in the UE's allowed CSG list. This UE autonomous search for CSG cells may also include CSG cells of communication technologies (e.g., radio access technologies (RATs)) other than those employed by a serving mobile network, or UTRAN. Furthermore, according to the specifications, the UE is required to perform the autonomous search function in Idle, Cell_PCH and URA_PCH states and the UE should disable the autonomous search function for CSG cells if the UE's allowed CSG list is empty.

The specification does not mandate, however, when and where the UE shall start the ASF—thus, this is left for UE implementation. In legacy cases, CSG cells are not always broadcasted in the system information blocks transmitted by the CSG cells; and for that reason, the UE must often perform exhaustive searches for the discovery of CSG cells. Unfortunately, such exhaustive searches require a nontrivial amount of battery power.

Therefore, methods and apparatuses for improved cell association fingerprinting are needed, such as those that limit the occurrence of exhaustive autonomous search functions so that they are only executed when necessary.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with maintaining a cell database for wireless communications.

In an aspect, a method of maintaining a cell database for wireless communications includes discovering a second cell to which a user equipment may reselect, wherein the user equipment is currently served by a first cell, and the second cell is a closed subscriber group cell. The method further includes querying a fingerprinting database determine whether the second cell was previously recorded in the fingerprinting database. Additionally, the method includes, upon determining that the second cell was not previously recorded, adding the second cell to the fingerprinting database. The adding of the second cell to the fingerprinting database may include indicating an association between the first cell and the second cell in the fingerprinting database.

In an aspect, a computer-program product comprising a non-transitory computer-readable medium may include code for causing a computer to discover a second cell to which a user equipment may reselect, wherein the user equipment may be currently served by a first cell and the second cell is a closed subscriber group cell. The computer-readable medium may include code for causing a computer to query a fingerprinting database to determine whether the second cell was previously recorded in the fingerprinting database. Upon determining that the second cell was not previously recorded, the computer-readable medium may include code for causing a computer to add the second cell to the fingerprinting database. Adding the second cell may include indicating an association between the first cell and the second cell in the fingerprinting database.

In an aspect, an apparatus for maintaining a cell database for wireless communications may include means for discovering a second cell to which a user equipment may reselect, wherein the user equipment may be currently served by a first cell and the second cell is a closed subscriber group cell. The apparatus may include means for querying a fingerprinting database to determine whether the second cell was previously recorded in the fingerprinting database. Upon determining that the second cell was not previously recorded, the apparatus may include means for adding the second cell to the fingerprinting database. Adding the second cell may include indicating an association between the first cell and the second cell in the fingerprinting database.

In an aspect, an apparatus for maintaining a cell database for wireless communications may include a reselection component for discovering a second cell to which a user equipment may reselect, wherein the user equipment may be currently served by a first cell and the second cell is a closed subscriber group cell. The apparatus may include a fingerprinting database querying component for querying a fingerprinting database to determine whether the second cell was previously recorded in the fingerprinting database. The apparatus may include a fingerprinting manager for, upon determining that the second cell was not previously recorded, adding the second cell to the fingerprinting database. Adding the second cell may include indicating an association between the first cell and the second cell in the fingerprinting database.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless system of aspects of the present disclosure;

FIG. 2 is a block diagram illustrating an example of a computer device in aspects of the present disclosure;

FIG. 3 is a flow diagram illustrating aspects of a method for improved cell fingerprinting as provided by the present disclosure;

FIG. 4 is a component diagram illustrating aspects of a logical grouping of electrical components as contemplated by the present disclosure;

FIG. 5 is a block diagram illustrating an example of a hardware implementation for an apparatus employing a processing system;

FIG. 6 is a block diagram conceptually illustrating an example of a telecommunications system;

FIG. 7 is a conceptual diagram illustrating an example of an access network;

FIG. 8 is a conceptual diagram illustrating an example of a radio protocol architecture for the user and control plane; and

FIG. 9 is a block diagram conceptually illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present disclosure provides methods and apparatuses for maintaining associations between wireless cells serving one or more user equipment (UE) by maintaining a fingerprinting database. Thus, in an aspect, the present disclosure presents methods of maintaining cell associations such that where a particular cell is associated with one or more other cells in some way, one or more of the cells may be fingerprinted to the other cell or cells.

For example, in an aspect, the first time that a UE reselects its serving cell from a first cell to a second cell, a fingerprinting manager or fingerprinting component at the UE and/or one or more of the network entities (e.g., NodeB, eNodeB, base station, femtocell, picocell, or other wireless cell serving device) may create or update one or more elements associated with the first and/or second cell in a fingerprinting database. In another example, the UE, currently camped on a first cell, may discover a second cell to which the UE may successfully reselect in the future. The second cell may be discovered through, for example, the UE's local search and measurement outcome. In response to the discovery of the second cell, and not necessarily the UE reselecting to the second cell from the first cell, the fingerprinting manager or fingerprinting component at the UE and/or one or more of the network entities may create or update one or more elements associated with the first and/or second cell in a fingerprinting database. In an aspect, the one or more elements may include an identifier corresponding to the first cell and/or second cell. In some examples, this identifier may comprise the cell Public Land Mobile Network (PLMN), Absolute Radio Frequency Channel Number (ARFCN), and/or its cell identification number.

Furthermore, the first cell may be a macro cell (e.g., a cellular network cell and/or sector), though the first cell may also be any other wireless cell (e.g., a picocell, femtocell, WiFi cell, or the like). Additionally, the first cell and second cell may operate according to different communication technologies, such as, but not limited to, GSM, WCDMA, and/or LTE. In addition, the second cell may be a closed subscriber group (CSG) cell, and may be a picocell, femtocell, WiFi cell, or the like (though the second cell may be a macro cell or larger wireless network serving cell as well).

In an additional aspect, a neighbor cell list of the second cell may be fingerprinted to the second cell. The neighbor cell list may be obtained either from the network associated with the first cell or the second cell, from the UE's local search and measurement outcome when camped on the first cell before reselection, and/or the second cell after reselection. Alternatively or additionally, the neighbor cell list of the second cell can also be fingerprinted to the first cell (and/or vice versa). Again, this neighbor list may be obtained either from the network or from the UE's local search and measurement outcome after the UE has camped on the second cell, though it may be obtained from another source at the UE and/or the first or second cells. Additionally, the second cell, which may be one or more CSG cells, may be identified by its PLMN, Absolute Radio Frequency Channel Number (ARFCN), cell identification number, the CSG ID, and/or a homeNodeB name (HNB).

In an additional aspect of the present disclosure, where an association between two or more cells is established (e.g., a fingerprint entry associating the two cells), for example, at cell discovery or reselection, the UE and/or one or more of the first and second cells may create or update a timestamp of the association or fingerprint. This timestamp may allow the fingerprinting database entries to be updated after expiration of a timer. For example, where such a timer expires without the occurrence of a subsequent association or fingerprinting update, the UE and/or the first or second cell may remove the association between the cells.

Thus, where a UE reselects its serving cell from a first cell to a second cell, the UE may query a fingerprinting database to determine whether the second cell is an existing entry in the fingerprinting database. If no such entry exists, the second cell, the first cell, and/or an association between the cells may be added and/or timestamped. Alternatively, where such an entry already exists (i.e., was previously entered), then the UE may check whether the associated cell is an existing entry in the database. In another example, the UE may query the fingerprinting database in response to the UE discovering a second cell to which it may reselect from a first cell.

Additionally, if a cell in the database (e.g., second cell) has not been detected as associated with another cell in the database (e.g., first cell) after a certain amount of time, which may be tracked using one or more timers, then the UE can deem that fingerprint as out-of-date, and can remove or delete the fingerprint or association between the cells from the fingerprinting database. Furthermore, if the second cell only has one fingerprint (the first cell) upon expiry of a timer, then the second cell may also be removed or deleted from the database. In another aspect, a counter may be used by the UE to maintain a record of information about a cell and, if the counter reaches a threshold value, the UE may determine the cell to be out-of-date, and delete an entry associated with the cell in the fingerprinting database. For example, the counter may track a number of times the cell was discovered by the UE without a successful reselection to the cell by the UE.

Thus, by implementing the procedures outlined above and further described below, the UE may perform a limited cell search guided by the fingerprinting database, for instance, to find CSG cells associated with a currently serving cell, rather than performing a battery-draining traditional autonomous search function.

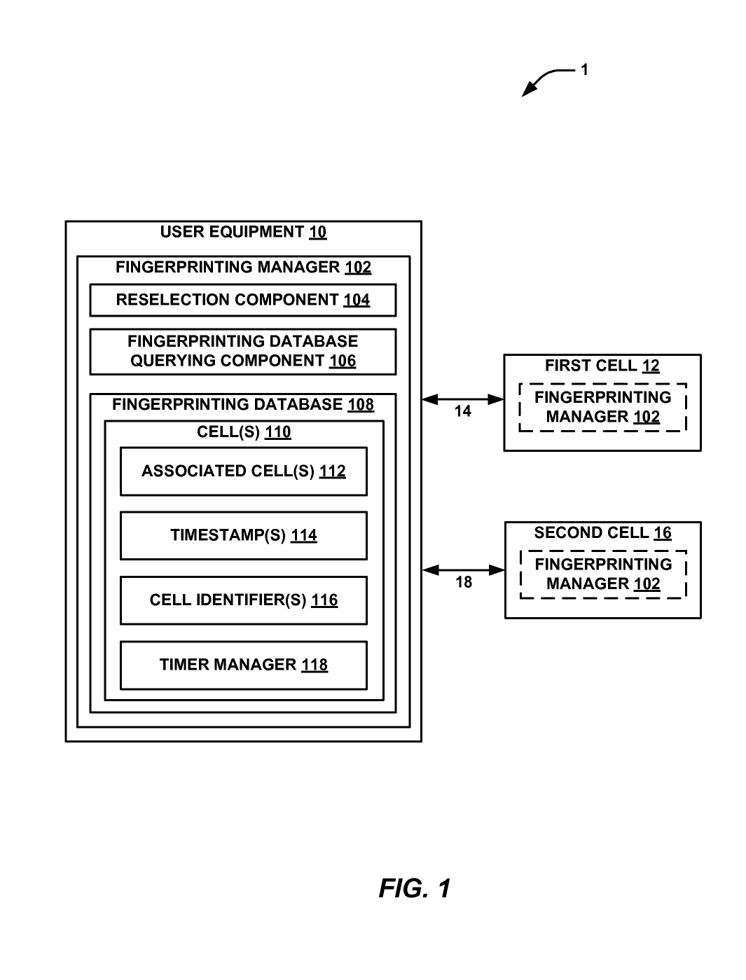

Referring to FIG. 1, a wireless communication system 1 is illustrated for improved cell selection using a maintained fingerprinting database. System 1 includes a UE 10 that may communicate with one or more cells, such as first cell 12 and/or a second cell 16 to receive wireless network access. In an aspect, first cell 12 may be an original serving cell and second cell 16 may be a cell to which the UE 10 reselects, or to which the UE 10 may be able to reselect, thus receiving wireless service from the second cell 16 upon reselection. In some non-limiting examples, the second cell 16 may be a CSG cell, first cell 12 may be a macro cell, and coverage areas between the first cell 12 and second cell 16 may overlap at least partially or may be otherwise associated. Thus, though not limited to this example, first cell 12 and second cell 16 may have an association due at least in part to these partially overlapping coverage areas.

In some examples, wireless communication between UE 10 and the cells may occur on one or more wireless links 14 and/or 18. In a further aspect, first cell 12 and/or second cell 16 may have an associated network component, such as an access point, including a base station (BS) or NodeB, a relay, a peer-to-peer device, a radio network controller (RNC), an authentication, authorization and accounting (AAA) server, a mobile switching center (MSC), picocell, piconode, femtocell, femtonode, WiFi access point, etc., that can enable UE 10 to communicate and/or that can establish and maintain a communication link, such as wireless links 14 and/or 18. In addition, UE 10 may be a multimode device, which may allow the UE to communicate with multiple technology type networks.

In addition, for purposes of the present disclosure the communication technology used for communication between one or more of UE 10, first cell 12, and second cell 16 may be of a 3G technology type, such as, but not limited to, data optimized (DO), WCDMA, Time Division Synchronous Code Division Multiple Access (TDS-CDMA), or any other third-generation mobile communications technology. Additionally, in some examples, the communication technology may be a 2G technology type, such as, but not limited to, GSM, GPRS, or EDGE. Furthermore, example RAT types may include more advanced RATs, such as, but not limited to, Long-Term Evolution (LTE), Time-Division Long-Term Evolution (TD-LTE), or any other fourth-generation mobile communications technology. Alternatively or additionally, any other communication technology type may be used for such communication.

Furthermore, UE 10 may include a fingerprinting manager 102, which may be configured to manage a fingerprinting database 108 that may store associations between one or more serving cells (e.g., first cell 12 and/or second cell 16). In an aspect, the fingerprinting manager 102 may alternatively or additionally be located at and/or maintained, by a network entity, such as a network entity associated with first cell 12 and/or second cell 16. In addition, fingerprinting manager 102 may include a reselection component 104, which may be configured to manage serving cell reselection for UE 10 (or one or more served UEs if fingerprinting manager 102 is located at a cell). In an aspect, reselection component 104 may periodically perform ASF or otherwise scan for pilot or beacon signals in an attempt to discover one or more cells not currently serving the UE. Alternatively or additionally, reselection component 104 may query a fingerprinting database 108 to determine whether one or more cells 110 are associated with a cell currently serving the UE, and if so, may limit its scan to one or more frequencies or channels associated with the one or more associated cells.

Alternatively, a fingerprinting database querying component 106, which may be associated with fingerprinting manager 102, may perform the fingerprinting database query. Furthermore, fingerprinting database querying component 106 may be configured to query fingerprinting database 108 to determine whether a cell newly discovered by reselection component 104 has been previously entered into the fingerprinting database 108.

In addition, as introduced above, fingerprinting manager 102 may include a fingerprinting database 108, which may be configured to store information related to one or more cells(s) 110. In an aspect, such information may include cell identifier(s) 116 that may include, but are not limited to, a PLMN, an Absolute Radio Frequency Channel Number (ARFCN), a cell identification number, a CSG ID, a HNB name, and/or any other cell identifying information. Furthermore, each cell 110 may include a list of one or more associated cells 112, which may also be identified by the above-mentioned identifying information or cell identifiers 116.

In an aspect, the list of one or more associated cells 112 may include a neighbor cell list of each cell 110 that is fingerprinted to each cell 110. This list may be obtained from the network associated with each cell 110, a network associated with the neighbor cells, directly from the neighbor cells, or from the UE's local search and measurement outcome when camped on the first cell before discovery or reselection and/or the second cell after discovery or reselection, though it may be obtained from another source at the UE and/or one of the cells 110. Additionally, the cells in the neighbor cell list may be one or more CSG cells, and may be identified by their PLMN, Absolute Radio Frequency Channel Number (ARFCN), cell identification number, the CSG ID, and/or a homeNodeB name (HNB).

Additionally, fingerprinting database 108 may include one or more timestamps 114 that may correspond to each cell 110 and any associated cells 112. In an aspect, fingerprinting database 108 may be configured to create and store a timestamp 114 when reselection component 104 discovers a cell, enters or updates that cell in an entry in fingerprinting database 108, and/or reselects the serving cell of UE 10 to the newly discovered cell. Furthermore, in an aspect, timer manager 118 may start a timer upon the creation of the timestamp. In addition, timer manager 118 may be configured to monitor each timer such that, for example, if an association between a first cell and a second cell (e.g., first cell 12 and second cell 16) is not reported or otherwise updated before the expiration of the timer, one or both of the first cell and second cell (or an indication of the association or fingerprint between the cells) may be determined to be out-of-date and discarded from the fingerprinting database 108. In another aspect, a counter may be used by the UE to maintain a record of information about a cell and, if the counter reaches a threshold value, the UE may determine the cell to be out-of-date, and delete an entry associated with the cell in the fingerprinting database. For example, the counter may track a number of times the cell was discovered by the UE without a successful reselection to the cell by the UE.

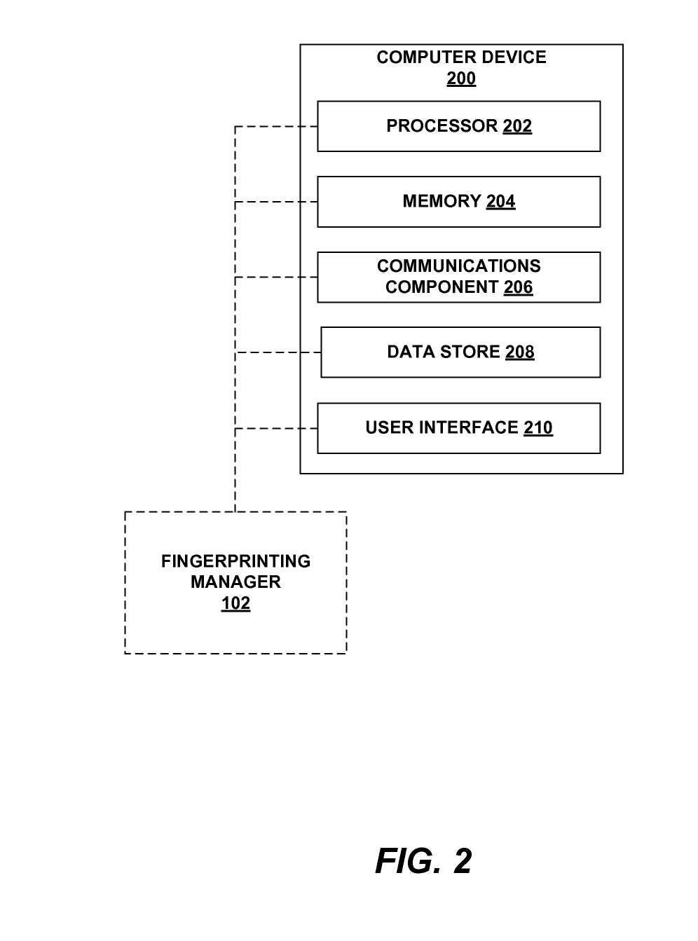

Referring to FIG. 2, in one aspect, any of UE 10, or the one or more network entities, such as first cell 12 and/or the optional second cell 16 (FIG. 1) may be represented by a specially programmed or configured computer device 200. Computer device 200 includes a processor 202 for carrying out processing functions associated with one or more of the components and functions described herein. Processor 202 can include a single or multiple set of processors or multi-core processors. Moreover, processor 202 can be implemented as an integrated processing system and/or a distributed processing system. Additionally, processor 202 may be configured to concatenate data received over a frame or several frames during a communication.

Computer device 200 further includes a memory 204, such as for storing data used herein and/or local versions of applications being executed by processor 202. Memory 204 can include any type of memory usable by a computer, such as random access memory (RAM), read only memory (ROM), tapes, magnetic discs, optical discs, volatile memory, non-volatile memory, and any combination thereof

Further, computer device 200 includes a communications component 206 that provides for establishing and maintaining communications with one or more parties utilizing hardware, software, and services as described herein. Communications component 206 may carry communications between components on computer device 200, as well as between computer device 200 and external devices, such as devices located across a communications network and/or devices serially or locally connected to computer device 200. For example, communications component 206 may include one or more buses, and may further include transmit chain components and receive chain components associated with a transmitter and receiver, respectively, or a transceiver, operable for interfacing with external devices. In an additional aspect, communications component 206 may be configured to receive one or more pages and/or page indicators from one or more subscriber networks. In a further aspect, such a page or page indicator may correspond to the second subscription and may be received via the first communication technology type communication services.

Additionally, computer device 200 may further include a data store 208, which can be any suitable combination of hardware and/or software, that provides for mass storage of information, databases, and programs employed in connection with aspects described herein. For example, data store 208 may be a data repository for applications not currently being executed by processor 202.

Computer device 200 may additionally include a user interface component 210 operable to receive inputs from a user of computer device 200, and further operable to generate outputs for presentation to the user. User interface component 210 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof Further, user interface component 210 may include one or more output devices, including but not limited to a display, a speaker, a haptic feedback mechanism, a printer, any other mechanism capable of presenting an output to a user, or any combination thereof In an additional aspect, a user using the user interface 210 may set one of a first subscription or a second subscription as a dedicated data service (DDS) for the computer device 200.

In a mobile station implementation, such as for UE 10 of FIG. 1, and/or a network entity implementation, such as a network entity associated with first cell 12 and/or second cell 16, computer device 200 may include fingerprinting manager 102 (FIG. 1), such as in specially programmed computer readable instructions or code, firmware, hardware, or some combination thereof

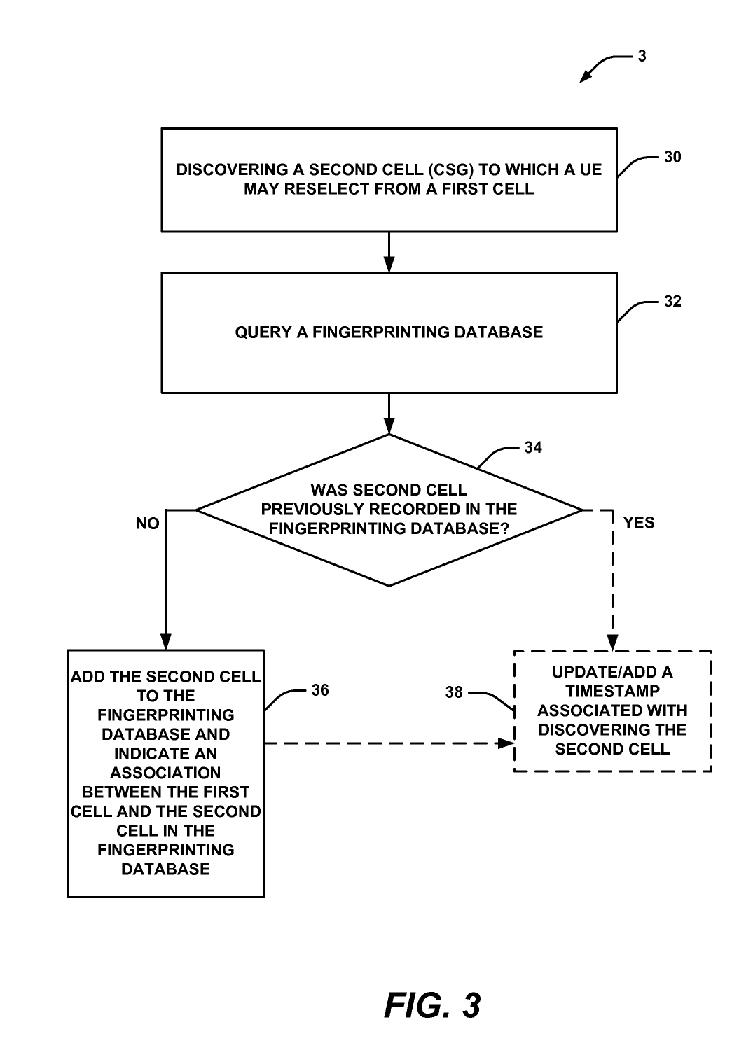

Referring to FIG. 3, an example methodology 3 for maintaining a fingerprinting database for cell association to minimize battery power consumption due to exhaustive ASF is presented. In an aspect, methodology 3 may be performed by components associated with a UE (e.g., UE 10) and/or a network component associated with a first or second cell (e.g., first cell 12 and/or second cell 16). While, for purposes of simplicity of explanation, the methodology 3 is described below in relation to a UE, again, the methodology 3 may be performed by a network entity. Additionally, the methodology 3 is shown and described as a series of acts, it is to be understood and appreciated that the methodologies are not limited by the order of acts, as some acts may, in accordance with one or more aspects, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more aspects.

In an aspect, at block 30, a UE (e.g., UE 10, FIG. 1) may discover a second cell to which the UE may reselect from a first cell, which is currently serving the UE. In an aspect, the second cell is a CSG. In another aspect, the second cell may be discovered by the UE upon the UE reselecting from the first cell to the second cell. Additionally, at block 32, the UE may query a fingerprinting database, and, through this querying, may determine, at block 34, whether the second cell was previously recorded in the fingerprinting database. In an aspect, where the UE determines at block 34 that the second cell was not previously recorded, the UE may add the second cell (e.g., by adding one or more cell identifiers corresponding to the second cell) to the fingerprinting database and indicate an association between the first cell and the second cell in the fingerprinting database at block 36. Furthermore, at block 38, in an optional aspect, the UE may additionally add a timestamp associated with the second cell upon the discovery of the second cell, where the second cell was not previously recorded. In an aspect, the UE may add the second cell to the fingerprinting database and indicate an association between the first cell and the second cell in the fingerprinting database, as shown at block 36, upon the UE reselecting to the second cell from the first cell, where the second cell was not previously recorded in the fingerprinting database. In addition, according to some examples of methodology 3, where the second cell was previously recorded in the fingerprinting database, the UE may update a timestamp associated with the second cell (or the association between the second cell and the first cell) upon the discovery of the second cell. In an aspect, the UE may optionally update a timestamp associated with the second cell (or the association between the second cell and the first cell), as shown at block 38, upon the UE reselecting to the second cell from the first cell, where the second cell was previously recorded in the fingerprinting database.

In an additional optional aspect of methodology 3 (this and below optional aspects not shown), the UE may start a timer upon discovery (or reselection) and/or storing/updating the second cell identifier(s) or the association between the first cell and the second cell in the fingerprinting database. In an aspect, the timer may be set based on a predetermined period of time. The predetermined period of time may be determined to have expired based on a timestamp and a current time reading. If the timer elapses, e.g., the predetermined period of time has expired, before the UE again updates the association and/or cell identifier, the UE may determine that the fingerprint of the second cell, e.g., the association between the first cell and the second cell in the fingerprinting database, is out-of-date. As a result, the UE may remove or delete one or more of the first and second cell entries in the fingerprinting database. Additionally or alternatively, the UE may delete a first cell entry in the fingerprinting database when the UE determines that the first cell is only associated with the second cell, upon removal of the second cell from the fingerprinting database.

In an aspect, a counter may be used by the UE to maintain a record of information about a cell and, if the counter reaches a threshold value, the UE may determine the cell to be out-of-date, and delete an entry associated with the cell in the fingerprinting database. For example, the counter may track a number of times the cell was discovered by the UE without a successful reselection to the cell by the UE.

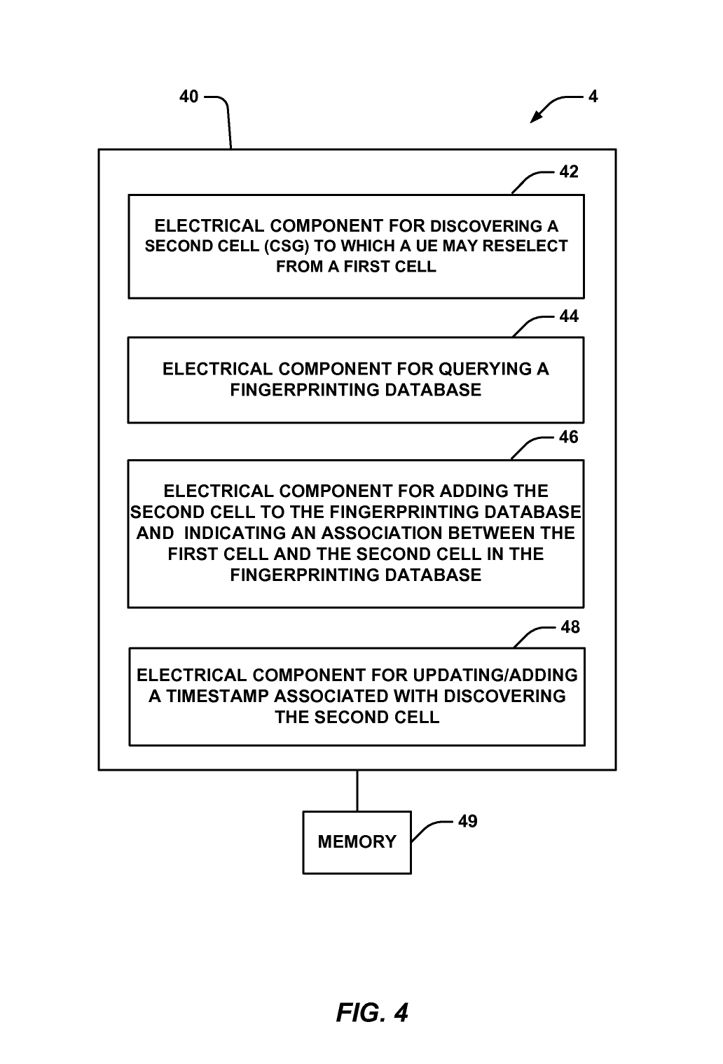

Referring to FIG. 4, an example system 4 is displayed for managing improved cell reselection using a fingerprinting database. For example, system 4 can reside at least partially within one or more network entities and/or UEs. It is to be appreciated that system 4 is represented as including functional blocks, which can be functional blocks that represent functions implemented by a processor, software, or combination thereof (e.g., firmware). System 4 includes a logical grouping 40 of electrical components that can act in conjunction. For instance, logical grouping 40 can include an electrical component 42 for discovering a second cell to which a UE may reselect from a first cell, which is currently serving the UE. In an aspect, the second cell is a CSG. In another aspect, electrical component 42 may discover the second cell as a result of the UE reselecting from the first cell to the second cell. In an aspect, electrical component 42 may comprise reselection component 104 (FIG. 1). In addition, logical grouping 40 can include an electrical component 44 for querying a fingerprinting database. In an aspect, electrical component 44 may comprise fingerprint database querying component 106 (FIG. 1). In an additional aspect, logical grouping 40 can include an electrical component 46 for adding the second cell to the fingerprinting database and indicating an association between the first cell and the second cell in the fingerprinting database. In an aspect, electrical component 46 may comprise control components of UE 10 configured to control fingerprinting database 108 (FIG. 1) and/or processor 202 (FIG. 2), which may alternatively or additionally be configured to add, edit, and/or delete entries to fingerprinting database 108. Furthermore, logical grouping 40 can include an electrical component 48 for updating or adding a timestamp (or starting a counter) in the fingerprinting database associated with discovering (or reselecting to) the second cell.

Additionally, system 4 can include a memory 49 that retains instructions for executing functions associated with the electrical components 42, 44, 46, and 48, and/or stores data used or obtained by the electrical components 42, 44, 46, and 48. While shown as being external to memory 49, it is to be understood that one or more of the electrical components 42, 44, 46, and 48 can exist within memory 49. In one example, electrical components 42, 44, 46, and 48 can comprise at least one processor, or each electrical component 42, 44, 46, and 48 can be a corresponding module of at least one processor. Moreover, in an additional or alternative example, electrical components 42, 44, 46, and 48 can be a computer program product including a computer readable medium, where each electrical component 42, 44, 46, and 48 can be corresponding code.

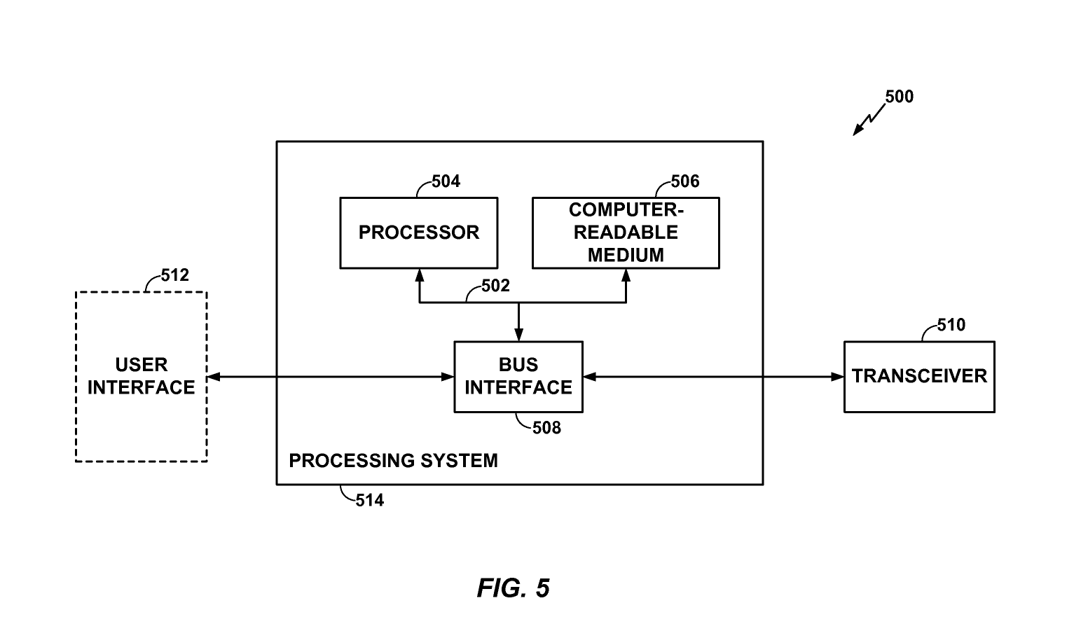

FIG. 5 is a block diagram illustrating an example of a hardware implementation for an apparatus 500 employing a processing system 514 for carrying out aspects of the present disclosure, such as methods for improved cell (e.g., CSG cell) scanning and discovery through maintenance of a fingerprinting database. In this example, the processing system 514 may be implemented with a bus architecture, represented generally by a bus 502. The bus 502 may include any number of interconnecting buses and bridges depending on the specific application of the processing system 514 and the overall design constraints. The bus 502 links together various circuits including one or more processors, represented generally by the processor 504, and computer-readable media, represented generally by the computer-readable medium 506. The bus 502 may also link various other circuits such as timing sources, peripherals, voltage regulators, and power management circuits, which are well known in the art, and therefore, will not be described any further. A bus interface 508 provides an interface between the bus 502 and a transceiver 510. The transceiver 510 provides a means for communicating with various other apparatus over a transmission medium. Depending upon the nature of the apparatus, a user interface 512 (e.g., keypad, display, speaker, microphone, joystick) may also be provided.

The processor 504 is responsible for managing the bus 502 and general processing, including the execution of software stored on the computer-readable medium 506. The software, when executed by the processor 504, causes the processing system 514 to perform the various functions described above for any particular apparatus. The computer-readable medium 506 may also be used for storing data that is manipulated by the processor 504 when executing software.

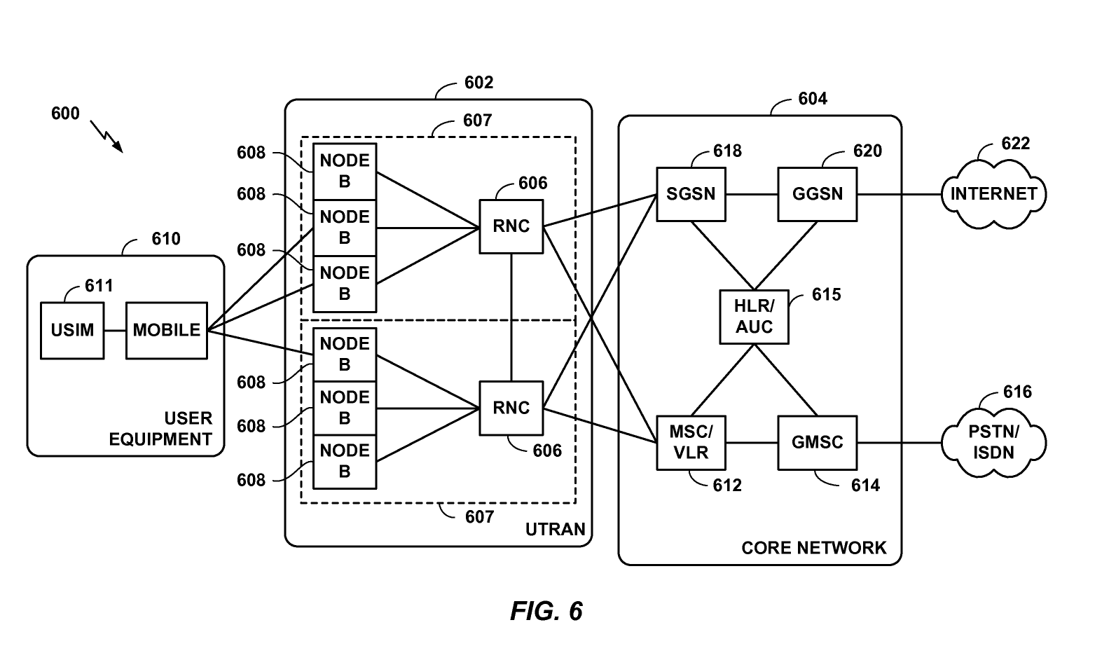

The various concepts presented throughout this disclosure may be implemented across a broad variety of telecommunication systems, network architectures, and communication standards. By way of example and without limitation, the aspects of the present disclosure illustrated in FIG. 6 are presented with reference to a UMTS system 600 employing a W-CDMA air interface, which may facilitate execution of one or methods contemplated by the present disclosure. A UMTS network includes three interacting domains: a Core Network (CN) 604, a UMTS Terrestrial Radio Access Network (UTRAN) 602, and User Equipment (UE) 610. In an aspect, UE 610 may be UE 10 (FIG. 1), and UMTS 602 may comprise first and/or second cells 12 and/or 16 (FIG. 1) and/or network entities serving these or other cells. In this example, the UTRAN 602 provides various wireless services including telephony, video, data, messaging, broadcasts, and/or other services. The UTRAN 602 may include a plurality of Radio Network Subsystems (RNSs) such as an RNS 607, each controlled by a respective Radio Network Controller (RNC) such as an RNC 606. Here, the UTRAN 602 may include any number of RNCs 606 and RNSs 607 in addition to the RNCs 606 and RNSs 607 illustrated herein. The RNC 606 is an apparatus responsible for, among other things, assigning, reconfiguring, and releasing radio resources within the RNS 607. The RNC 606 may be interconnected to other RNCs (not shown) in the UTRAN 602 through various types of interfaces such as a direct physical connection, a virtual network, or the like, using any suitable transport network.

Communication between a UE 610 and a NodeB 608 may be considered as including a physical (PHY) layer and a medium access control (MAC) layer. Further, communication between a UE 610 and an RNC 606 by way of a respective NodeB 608 may be considered as including a radio resource control (RRC) layer. In the instant specification, the PHY layer may be considered layer 1; the MAC layer may be considered layer 6; and the RRC layer may be considered layer 3. Information hereinbelow utilizes terminology introduced in the RRC Protocol Specification, 3GPP TS 65.331 v9.1.0, incorporated herein by reference.

The geographic region covered by the RNS 607 may be divided into a number of cells, with a radio transceiver apparatus serving each cell. A radio transceiver apparatus is commonly referred to as a NodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 608 are shown in each RNS 607; however, the RNSs 607 may include any number of wireless Node Bs. The Node Bs 608 provide wireless access points to a CN 604 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 610 may further include a universal subscriber identity module (USIM) 611, which contains a user's subscription information to a network. For illustrative purposes, one UE 610 is shown in communication with a number of the Node Bs 608. The DL, also called the forward link, refers to the communication link from a NodeB 608 to a UE 610, and the UL, also called the reverse link, refers to the communication link from a UE 610 to a NodeB 608.

The CN 604 interfaces with one or more access networks, such as the UTRAN 602. As shown, the CN 604 is a GSM core network. However, as those skilled in the art will recognize, the various concepts presented throughout this disclosure may be implemented in a RAN, or other suitable access network, to provide UEs with access to types of CNs other than GSM networks.

The CN 604 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 604 supports circuit-switched services with a MSC 612 and a GMSC 614. In some applications, the GMSC 614 may be referred to as a media gateway (MGW). One or more RNCs, such as the RNC 606, may be connected to the MSC 612. The MSC 612 is an apparatus that controls call setup, call routing, and UE mobility functions. The MSC 612 also includes a VLR that contains subscriber-related information for the duration that a UE is in the coverage area of the MSC 612. The GMSC 614 provides a gateway through the MSC 612 for the UE to access a circuit-switched network 616. The GMSC 614 includes a home location register (HLR) 615 containing subscriber data, such as the data reflecting the details of the services to which a particular user has subscribed. The HLR is also associated with an authentication center (AuC) that contains subscriber-specific authentication data. When a call is received for a particular UE, the GMSC 614 queries the HLR 615 to determine the UE's location and forwards the call to the particular MSC serving that location.

The CN 604 also supports packet-data services with a serving GPRS support node (SGSN) 618 and a gateway GPRS support node (GGSN) 620. GPRS, which stands for General Packet Radio Service, is designed to provide packet-data services at speeds higher than those available with standard circuit-switched data services. The GGSN 620 provides a connection for the UTRAN 602 to a packet-based network 622. The packet-based network 622 may be the Internet, a private data network, or some other suitable packet-based network. The primary function of the GGSN 620 is to provide the UEs 610 with packet-based network connectivity. Data packets may be transferred between the GGSN 620 and the UEs 610 through the SGSN 618, which performs primarily the same functions in the packet-based domain as the MSC 612 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a NodeB 608 and a UE 610. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 610 provides feedback to the node B 608 over the HS-DPCCH to indicate whether it correctly decoded a packet on the downlink.

HS-DPCCH further includes feedback signaling from the UE 610 to assist the node B 608 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 608 and/or the UE 610 may have multiple antennas supporting MIMO technology. The use of MIMO technology enables the node B 608 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 610 to increase the data rate or to multiple UEs 610 to increase the overall system capacity. This is achieved by spatially precoding each data stream and then transmitting each spatially precoded stream through a different transmit antenna on the downlink. The spatially precoded data streams arrive at the UE(s) 610 with different spatial signatures, which enables each of the UE(s) 610 to recover the one or more the data streams destined for that UE 610. On the uplink, each UE 610 may transmit one or more spatially precoded data streams, which enables the node B 608 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

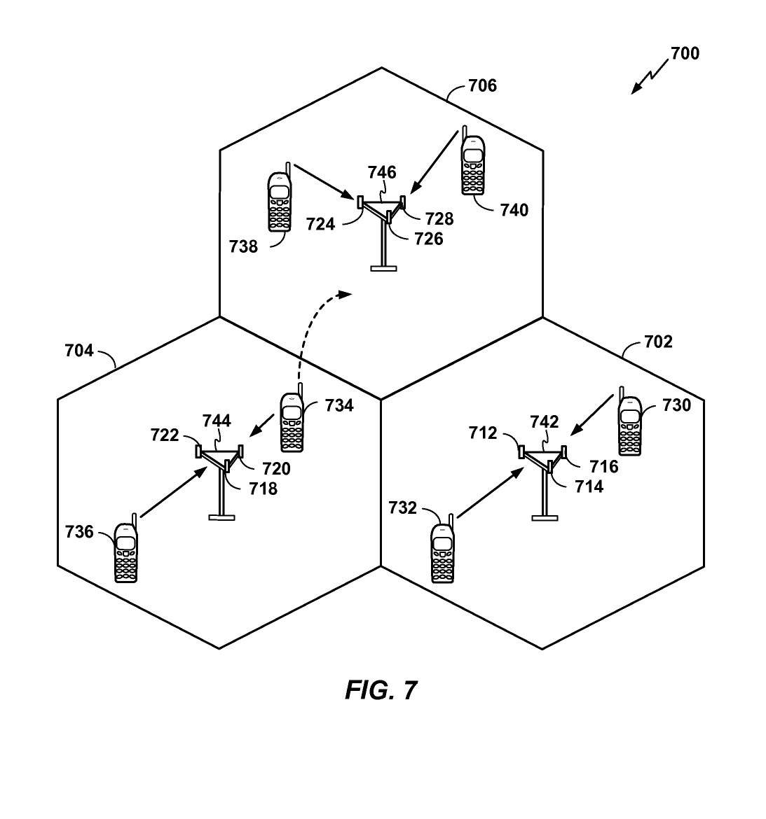

Referring to FIG. 7, an access network 700 in a UTRAN architecture is illustrated. The multiple access wireless communication system includes multiple cellular regions (cells), including cells 702, 704, and 706, each of which may include one or more sectors. The multiple sectors can be formed by groups of antennas with each antenna responsible for communication with UEs in a portion of the cell. For example, in cell 702, antenna groups 712, 714, and 716 may each correspond to a different sector. In cell 704, antenna groups 718, 720, and 722 each correspond to a different sector. In cell 706, antenna groups 724, 726, and 728 each correspond to a different sector. The cells 702, 704 and 706 may include several wireless communication devices, e.g., User Equipment or UEs, which may be in communication with one or more sectors of each cell 702, 704 or 706. For example, UEs 730 and 732 may be in communication with NodeB 742, UEs 734 and 736 may be in communication with NodeB 744, and UEs 738 and 740 can be in communication with NodeB 746. Here, each NodeB 742, 744, 746 is configured to provide an access point to a core network for all the UEs 730, 732, 734, 736, 738, 740 in the respective cells 702, 704, and 706.

In one example, UE 734 may be the UE 610 of FIG. 6 and/or UE 10 of FIG. 1, and cell 706 may be the NodeB 608 in FIG. 6 and/or first and/or second cells 12 and/or 16 of FIG. 1.

As the UE 734 moves from the illustrated location in cell 704 into cell 706, a serving cell change (SCC) or handover may occur in which communication with the UE 734 transitions from the cell 704, which may be referred to as the source cell, to cell 706, which may be referred to as the target cell. Management of the handover procedure may take place at the UE 734, at the Node Bs corresponding to the respective cells, at a radio network controller 606 (FIG. 6), or at another suitable node in the wireless network. For example, during a call with the source cell 704, or at any other time, the UE 734 may monitor various parameters of the source cell 704 as well as various parameters of neighboring cells such as cells 706 and 702. Further, depending on the quality of these parameters, the UE 734 may maintain communication with one or more of the neighboring cells. During this time, the UE 734 may maintain an Active Set, that is, a list of cells that the UE 734 is simultaneously connected to (i.e., the UTRA cells that are currently assigning a downlink dedicated physical channel DPCH or fractional downlink dedicated physical channel F-DPCH to the UE 734 may constitute the Active Set).

The modulation and multiple access scheme employed by the access network 700 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

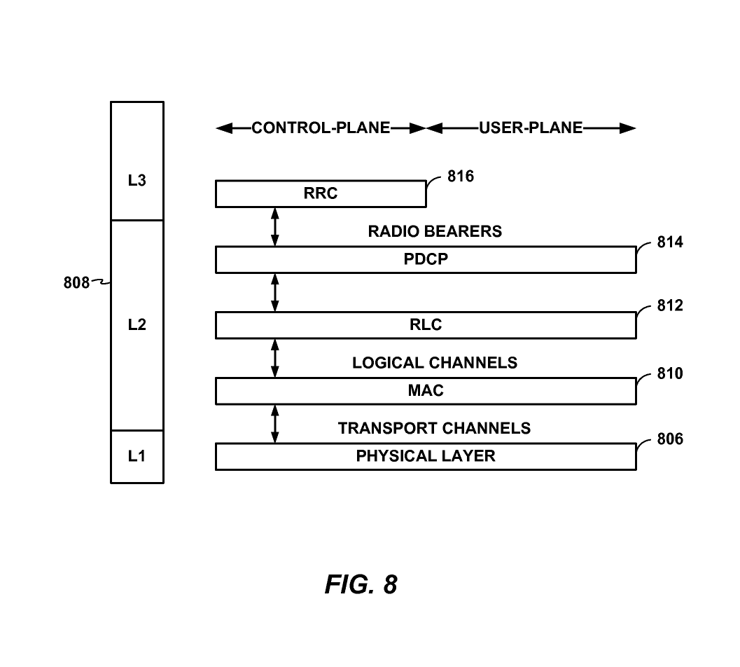

The radio protocol architecture may take on various forms depending on the particular application. An example for an HSPA system will now be presented with reference to FIG. 8. FIG. 8 is a conceptual diagram illustrating an example of the radio protocol architecture for the user and control planes.

Turning to FIG. 8, the radio protocol architecture for the UE and node B is shown with three layers: Layer 1, Layer 2, and Layer 3, where the UE may be the UE 610 of FIG. 6 and/or UE 10 of FIG. 1 and the node B may be the NodeB 608 of FIG. 6. Layer 1 is the lowest lower and implements various physical layer signal processing functions. Layer 1 will be referred to herein as the physical layer 806. Layer 2 (L2 layer) 808 is above the physical layer 806 and is responsible for the link between the UE and node B over the physical layer 806.

In the user plane, the L2 layer 808 includes a media access control (MAC) sublayer 810, a radio link control (RLC) sublayer 812, and a packet data convergence protocol (PDCP) 814 sublayer, which are terminated at the node B on the network side. Although not shown, the UE may have several upper layers above the L2 layer 808 including a network layer (e.g., IP layer) that is terminated at a PDN gateway on the network side, and an application layer that is terminated at the other end of the connection (e.g., far end UE, server, etc.).

The PDCP sublayer 814 provides multiplexing between different radio bearers and logical channels. The PDCP sublayer 814 also provides header compression for upper layer data packets to reduce radio transmission overhead, security by ciphering the data packets, and handover support for UEs between NodeBs. The RLC sublayer 812 provides segmentation and reassembly of upper layer data packets, retransmission of lost data packets, and reordering of data packets to compensate for out-of-order reception due to hybrid automatic repeat request (HARQ). The MAC sublayer 810 provides multiplexing between logical and transport channels. The MAC sublayer 810 is also responsible for allocating the various radio resources (e.g., resource blocks) in one cell among the UEs. The MAC sublayer 810 is also responsible for HARQ operations.

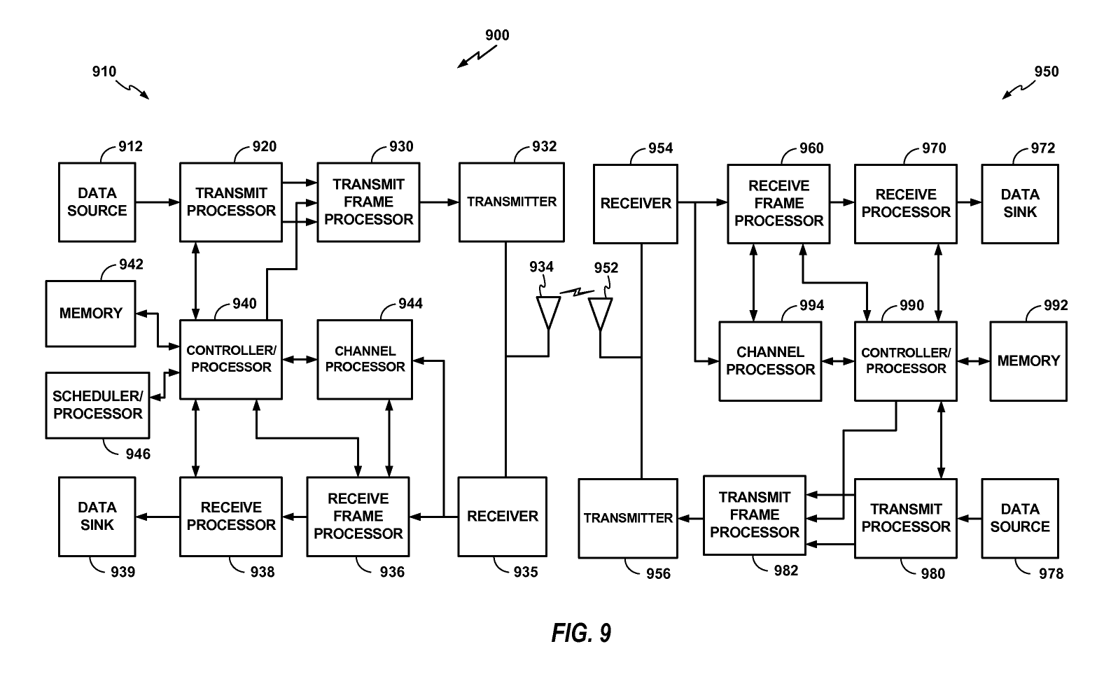

FIG. 9 is a block diagram of a NodeB 910 in communication with a UE 950, where the NodeB 910 may be the NodeB 608 in FIG. 6 and/or first and/or second cells 12 and/or 16 of FIG. 1, and the UE 950 may be the UE 610 in FIG. 6 and/or UE 10 of FIG. 1. In the downlink communication, a transmit processor 920 may receive data from a data source 912 and control signals from a controller/processor 940. The transmit processor 920 provides various signal processing functions for the data and control signals, as well as reference signals (e.g., pilot signals). For example, the transmit processor 920 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 944 may be used by a controller/processor 940 to determine the coding, modulation, spreading, and/or scrambling schemes for the transmit processor 920. These channel estimates may be derived from a reference signal transmitted by the UE 950 or from feedback from the UE 950. The symbols generated by the transmit processor 920 are provided to a transmit frame processor 930 to create a frame structure. The transmit frame processor 930 creates this frame structure by multiplexing the symbols with information from the controller/processor 940, resulting in a series of frames. The frames are then provided to a transmitter 932, which provides various signal conditioning functions including amplifying, filtering, and modulating the frames onto a carrier for downlink transmission over the wireless medium through antenna 934. The antenna 934 may include one or more antennas, for example, including beam steering bidirectional adaptive antenna arrays or other similar beam technologies.

At the UE 950, a receiver 954 receives the downlink transmission through an antenna 952 and processes the transmission to recover the information modulated onto the carrier. The information recovered by the receiver 954 is provided to a receive frame processor 960, which parses each frame, and provides information from the frames to a channel processor 994 and the data, control, and reference signals to a receive processor 970. The receive processor 970 then performs the inverse of the processing performed by the transmit processor 920 in the NodeB 910. More specifically, the receive processor 970 descrambles and despreads the symbols, and then determines the most likely signal constellation points transmitted by the NodeB 910 based on the modulation scheme. These soft decisions may be based on channel estimates computed by the channel processor 994. The soft decisions are then decoded and deinterleaved to recover the data, control, and reference signals. The CRC codes are then checked to determine whether the frames were successfully decoded. The data carried by the successfully decoded frames will then be provided to a data sink 972, which represents applications running in the UE 950 and/or various user interfaces (e.g., display). Control signals carried by successfully decoded frames will be provided to a controller/processor 990. When frames are unsuccessfully decoded by the receiver processor 970, the controller/processor 990 may also use an acknowledgement (ACK) and/or negative acknowledgement (NACK) protocol to support retransmission requests for those frames.

In the uplink, data from a data source 978 and control signals from the controller/processor 990 are provided to a transmit processor 980. The data source 978 may represent applications running in the UE 950 and various user interfaces (e.g., keyboard). Similar to the functionality described in connection with the downlink transmission by the NodeB 910, the transmit processor 980 provides various signal processing functions including CRC codes, coding and interleaving to facilitate FEC, mapping to signal constellations, spreading with OVSFs, and scrambling to produce a series of symbols. Channel estimates, derived by the channel processor 994 from a reference signal transmitted by the NodeB 910 or from feedback contained in the midamble transmitted by the NodeB 910, may be used to select the appropriate coding, modulation, spreading, and/or scrambling schemes. The symbols produced by the transmit processor 980 will be provided to a transmit frame processor 982 to create a frame structure. The transmit frame processor 982 creates this frame structure by multiplexing the symbols with information from the controller/processor 990, resulting in a series of frames. The frames are then provided to a transmitter 956, which provides various signal conditioning functions including amplification, filtering, and modulating the frames onto a carrier for uplink transmission over the wireless medium through the antenna 952.

The uplink transmission is processed at the NodeB 910 in a manner similar to that described in connection with the receiver function at the UE 950. A receiver 935 receives the uplink transmission through the antenna 934 and processes the transmission to recover the information modulated onto the carrier. The information recovered by the receiver 935 is provided to a receive frame processor 936, which parses each frame, and provides information from the frames to the channel processor 944 and the data, control, and reference signals to a receive processor 938. The receive processor 938 performs the inverse of the processing performed by the transmit processor 980 in the UE 950. The data and control signals carried by the successfully decoded frames may then be provided to a data sink 939 and the controller/processor, respectively. If some of the frames were unsuccessfully decoded by the receive processor, the controller/processor 940 may also use an acknowledgement (ACK) and/or negative acknowledgement (NACK) protocol to support retransmission requests for those frames.

The controller/processors 940 and 990 may be used to direct the operation at the NodeB 910 and the UE 950, respectively. For example, the controller/processors 940 and 990 may provide various functions including timing, peripheral interfaces, voltage regulation, power management, and other control functions. The computer readable media of memories 942 and 992 may store data and software for the NodeB 910 and the UE 950, respectively. A scheduler/processor 946 at the NodeB 910 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of maintaining a cell database for wireless communications, comprising:
discovering a second cell to which a user equipment may reselect, wherein the user equipment is currently being served by a first cell and the second cell is a closed subscriber group cell;
querying a fingerprinting database to determine whether the second cell was previously recorded in the fingerprinting database; and
upon determining that the second cell was not previously recorded, adding the second cell to the fingerprinting database, wherein adding the second cell comprises indicating an association between the first cell and the second cell in the fingerprinting database.

2. The method of claim 1, wherein discovering a second cell to which a user equipment may reselect comprises the user equipment reselecting from the first cell to the second cell.

3. The method of claim 1, further comprising:
reselecting a serving cell associated with the user equipment from the first cell to the second cell;
discovering a neighbor cell to which the user equipment may reselect from the second cell, wherein the user equipment is currently being served by the second cell;
querying the fingerprinting database to determine whether the neighbor cell was previously recorded in the fingerprinting database; and
upon determining that the neighbor cell was not previously recorded, adding the neighbor cell to the fingerprinting database, wherein adding the neighbor cell to the fingerprinting database comprises indicating an association between at least two of the first cell, the second cell, and the neighbor cell in the fingerprinting database.

4. The method of claim 3, wherein discovering the neighbor cell comprises receiving a list, of one or more neighboring cells to which the user equipment may reselect, from a network associated with the user equipment.

5. The method of claim 3, wherein discovering the neighbor cell comprises discovering the neighbor cell by the user equipment based on a local search and measurement outcome of the user equipment.

6. The method of claim 1, wherein adding the second cell to the fingerprinting database further comprises identifying the second cell by one or more of a Public Land Mobile Network (PLMN) identifier, an Absolute Radio Frequency Channel Number (ARFCN), a CSG identifier, and a cell identifier.

7. The method of claim 1, further comprising adding the first cell to the fingerprinting database where the first cell was not previously recorded in the fingerprinting database.

8. The method of claim 1, wherein the first cell comprises at least one of a macro cell, a pico cell, and a femto cell.

9. The method of claim 1, wherein the second cell comprises at least one of a macro cell, a pico cell, and a femto cell.

10. The method of claim 1, wherein adding the second cell to the fingerprinting database further comprises adding a timestamp associated with the discovering of the second cell.

11. The method of claim 1, further comprising updating a timestamp associated with the second cell upon the discovering, wherein the second cell was previously recorded in the fingerprinting database.

12. The method of claim 1, further comprising:
determining a period of time,
identifying a third cell to which the user equipment may select from the first cell, wherein the third cell comprises a closed subscriber group and the third cell has been previously recorded in the fingerprinting database,
determining that the fingerprint of the third cell in the fingerprinting database is out-of-date; and
removing the third cell from the fingerprinting database.

13. The method of claim 9, further comprising:
determining that the third cell is associated with only one other cell; and
removing the one other cell from the fingerprinting database.

14. The method of claim 9, wherein determining that the fingerprint of the third cell in the fingerprinting database is out-of-date comprises determining that a period of time has expired, wherein the period of time may be determined based upon a timestamp associated with the third cell in the fingerprinting database.

15. The method of claim 9, wherein determining that the fingerprint of the third cell in the fingerprinting database is out-of-date comprises determining that a counter associated with the third cell in the fingerprinting database has reached a threshold value.

16. A computer-program product, comprising:
non-transitory computer-readable medium, comprising:
code for causing a computer to:
discover a second cell to which a user equipment may reselect, wherein the user equipment is currently being served by a first cell and the second cell is a closed subscriber group cell;
query a fingerprinting database to determine whether the second cell was previously recorded in the fingerprinting database; and
upon determining that the second cell was not previously recorded, add the second cell to the fingerprinting database, wherein adding the second cell comprises indicating an association between the first cell and the second cell in the fingerprinting database.

17. An apparatus for maintaining a cell database for wireless communications, comprising:
means for discovering a second cell to which a user equipment may reselect, wherein the user equipment is currently being served by a first cell and the second cell is a closed subscriber group cell;
means for querying a fingerprinting database to determine whether the second cell was previously recorded in the fingerprinting database; and
upon determining that the second cell was not previously recorded, means for adding the second cell to the fingerprinting database, wherein adding the second cell comprises indicating an association between the first cell and the second cell in the fingerprinting database.

18. An apparatus for maintaining a cell database for wireless communications, comprising:
a reselection component for discovering a second cell to which a user equipment may reselect, wherein the user equipment is currently being served by a first cell and the second cell is a closed subscriber group cell;
a fingerprinting database querying component for querying a fingerprinting database to determine whether the second cell was previously recorded in the fingerprinting database; and
a fingerprinting manager for, upon determining that the second cell was not previously recorded, adding the second cell to the fingerprinting database, wherein adding the second cell comprises indicating an association between the first cell and the second cell in the fingerprinting database.

19. The apparatus of claim 18, wherein the reselection component for discovering a second cell to which a user equipment may reselect is further for reselecting from the first cell to the second cell.

20. The apparatus of claim 18, wherein:
the reselection component is further for:
reselecting a serving cell associated with the user equipment from the first cell to the second cell, and
discovering a neighbor cell to which the user equipment may reselect from the second cell, wherein the user equipment is currently being served by the second cell;
the fingerprinting database querying component is further for querying the fingerprinting database to determine whether the neighbor cell was previously recorded in the fingerprinting database; and
upon determining that the neighbor cell was not previously recorded, the fingerprinting manager is further for adding the neighbor cell to the fingerprinting database, wherein adding the neighbor cell to the fingerprinting database comprises indicating an association between at least two of the first cell, the second cell, and the neighbor cell in the fingerprinting database.

21. The apparatus of claim 20, wherein the reselection component for discovering the neighbor cell comprises the reselection component is further for receiving a list, of one or more neighboring cells to which the user equipment may reselect, from a network associated with the user equipment.

22. The apparatus of claim 20, wherein the reselection component for discovering the neighbor cell comprises the reselection component is further for discovering the neighbor cell by the user equipment based on a local search and measurement outcome of the user equipment.

23. The apparatus of claim 18, wherein the fingerprinting manager for adding the second cell to the fingerprinting database is further for identifying the second cell by one or more of a Public Land Mobile Network (PLMN) identifier, an Absolute Radio Frequency Channel Number (ARFCN), a CSG identifier, and a cell identifier.

24. The apparatus of claim 18, wherein the fingerprinting manager is further for adding the first cell to the fingerprinting database where the first cell was not previously recorded in the fingerprinting database.

25. The apparatus of claim 18, wherein the first cell comprises at least one of a macro cell, a pico cell, and a femto cell.

26. The apparatus of claim 18, wherein the second cell comprises at least one of a macro cell, a pico cell, and a femto cell.

27. The apparatus of claim 18, wherein the fingerprinting manager for adding the second cell to the fingerprinting database is further for adding a timestamp associated with the discovering of the second cell.

28. The apparatus of claim 18, wherein the fingerprinting manager is further for updating a timestamp associated with the second cell upon the discovering, wherein the second cell was previously recorded in the fingerprinting database.

29. The apparatus of claim 18, wherein:
the fingerprinting manager is further for determining a period of time,
the reselection component is further for identifying a third cell to which the user equipment may select from the first cell, wherein the third cell comprises a closed subscriber group and the third cell has been previously recorded in the fingerprinting database,
the fingerprinting database querying component is further for:
determining that the fingerprint of the third cell in the fingerprinting database is out-of-date, and
removing the third cell from the fingerprinting database.

30. The apparatus of claim 18, wherein:
the fingerprinting database querying component is further for:
determining that the third cell is associated with only one other cell, and
removing the one other cell from the fingerprinting database.

31. The apparatus of claim 30, wherein the fingerprinting database querying component for determining that the fingerprint of the third cell in the fingerprinting database is out-of-date is further for determining that a period of time has expired, wherein the period of time may be determined based upon a timestamp associated with the third cell in the fingerprinting database.

32. The apparatus of claim 30, wherein the fingerprinting database querying component for determining that the fingerprint of the third cell in the fingerprinting database is out-of-date is further for determining that a counter associated with the third cell in the fingerprinting database has reached a threshold value.
